(19) United States
(12) Patent Application Publication
(10) Pub. No.: US 2026/0015180 A1
(43) Pub. Date: Jan. 15, 2026

(54) CONVEYOR PULLEY SYSTEMS, METHODS, AND APPARATUS

(71) Applicant: Superior Industries, Inc., Morris, MN (US)

(72) Inventors: Paul Schmidgall, Morris, MN (US); James Solvie, Morris, MN (US)

(21) Appl. No.: 19/139,754

(22) PCT Filed: Dec. 13, 2023
(86) PCT No.: PCT/US23/83771

§ 371 Date: Jun. 16, 2025

Related U.S. Application Data
(60) Provisional application No. 63/387,840, filed on Dec. 16, 2022.

(51) Int. Cl. B65G 23/04; B65G 39/02

(52) U.S. Cl. CPC B65G 23/04; B65G 39/02; B65G 2812/02306

(57) ABSTRACT

Conveyor pulley embodiments are provided. In some embodiments, a lower portion of a wing portion of the conveyor pulley is curved to complement an exterior surface of the body of the conveyor pulley. In some embodiments, an upper portion of a wing portion of the conveyor pulley is curved so as to complement an imaginary cylindrical surface along which the pulley supports a conveyor belt.

### BACKGROUND

Conveyor pulleys support, drive, and/or otherwise interact with the endless belt of a belt conveyor.

### BRIEF DESCRIPTION OF THE DRAWINGS

FIG. 1 is a perspective view of an embodiment of a conveyor pulley.

FIG. 2 is top view of the conveyor pulley of FIG. 1.

FIG. 3 is a side view of the conveyor pulley of FIG. 1.

FIG. 4 is an expanded portion of the view of FIG. 3.

FIG. 5 is a perspective view of an embodiment of a wing of the conveyor pulley of FIG. 1.

FIG. 6 is another perspective view of the wing of FIG. 5.

FIG. 7 is another perspective view of the conveyor pulley embodiment of FIG. 1.

FIG. 8 is a sectional view along the section 8-8 of FIG. 2, with a portion of an embodiment of an endless belt additionally illustrated.

FIG. 9 is a perspective view of another embodiment of a conveyor pulley.

FIG. 10 is a perspective view of still another embodiment of a conveyor pulley.

FIG. 11 is a close-up side view of still another embodiment of a conveyor pulley.

FIG. 12 schematically illustrates an embodiment of a process for making one or more conveyor pulley embodiments.

### DESCRIPTION

Pulleys such as wing pulleys may be employed in a conveyor (e.g., at the tail end of a belt conveyor).

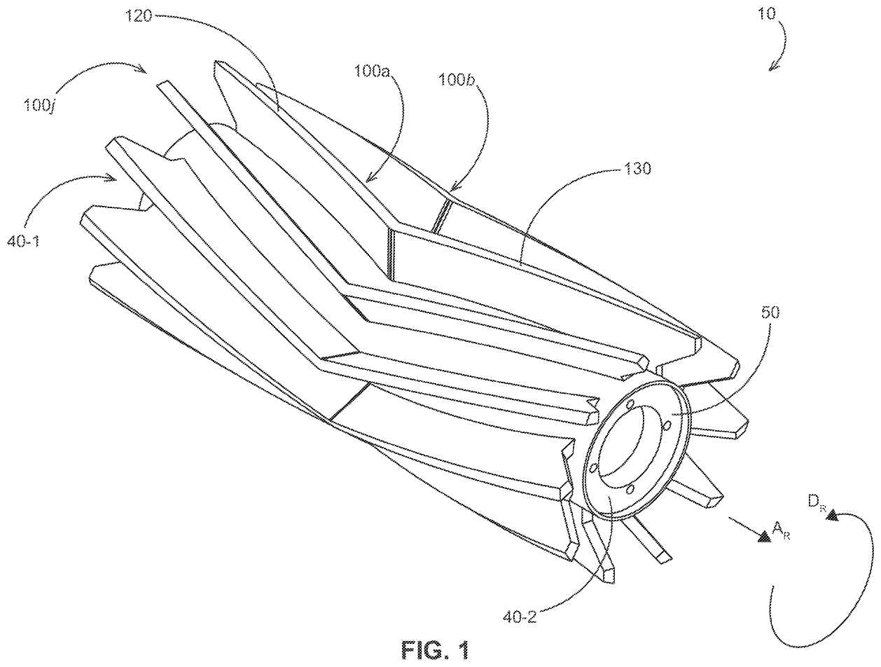

Referring to the drawings, wherein like reference numerals designate identical or corresponding parts throughout the several views, FIG. 1 illustrates an embodiment of a conveyor pulley 10. The conveyor optionally includes a body 50 (e.g., drum, cylinder, etc.). The body 50 is optionally supportable on a shaft (not shown) centered about an axis of rotation AR for rotation with or relative to the shaft (e.g., for rotation with a rotating shaft or rotation relative to a stationary shaft), e.g., along a direction of rotation D_{R}. The body 50 is optionally operably couplable to a shaft by a bearing or bearing assembly (not shown) which may be mounted to each of two end portions 40-1, 40-2 mounted to opposing ends of the body 50.

The pulley 10 optionally comprises a plurality of wings 100 mounted to (e.g., welded to) the body 50 and arranged circumferentially about the body 50 (e.g., about the axis of rotation AR of the body 50). In the illustrated embodiment, the pulley 10 comprises 10 wings (100a, 100b, 100c, 100d, 100e, 100f, 100g, 100h, 100i, 100j); in other embodiments, a pulley comprises various numbers of wings (e.g., 6 wings, 8 wings, 10 wings, more than 4 wings, less than 20 wings, between 5 and 15 wings, etc.).

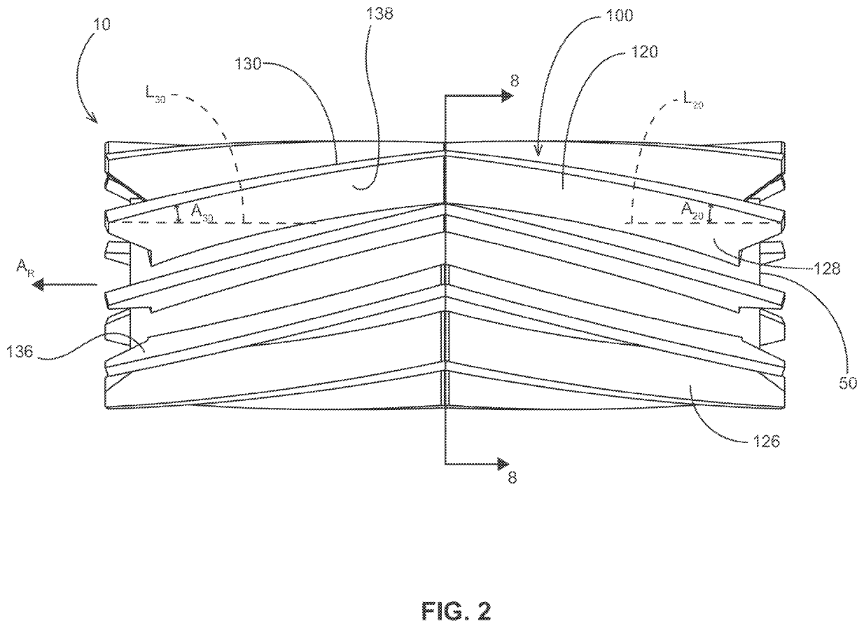

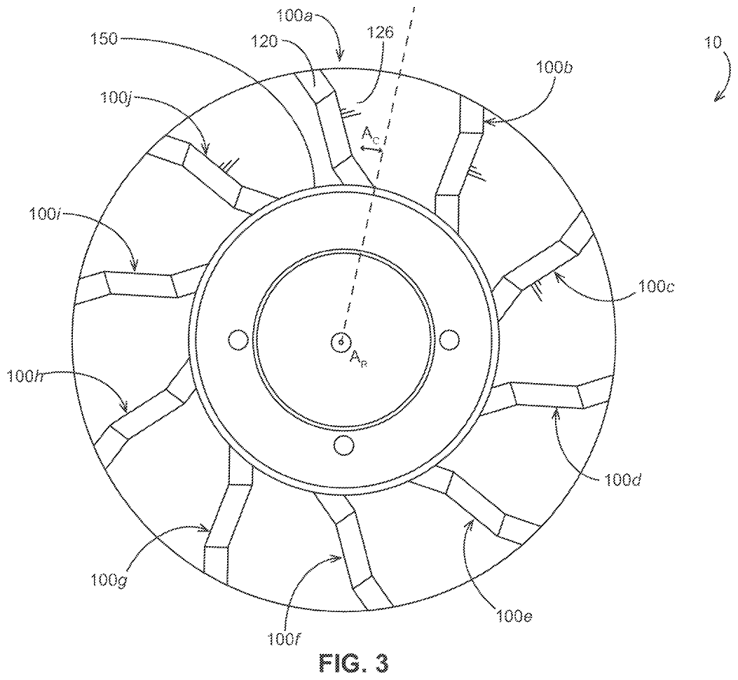

In some embodiments, each wing 100 optionally comprises a first wing portion 120 and a second wing portion 130. Referring to FIG. 2, in some embodiments, each wing portion is optionally angled forward of (or optionally extends at an angle (e.g., oblique angle) with respect to) a line L intersecting an outer end of the wing portion and parallel to the axis of rotation AR. As a first example, wing portion 120 is optionally angled forward of line L₂₀ by a non-zero angle A₂₀. As a second example, wing portion 130 is optionally angled forward of line L₃₂ by a non-zero angle A₃₀. Each wing portion is optionally angled forward of the associated line L along the direction of rotation D_{R}. Referring to FIG. 3, each wing portion is optionally angled forward of a line extending radially from the axis of rotation by a non-zero angle Ac.

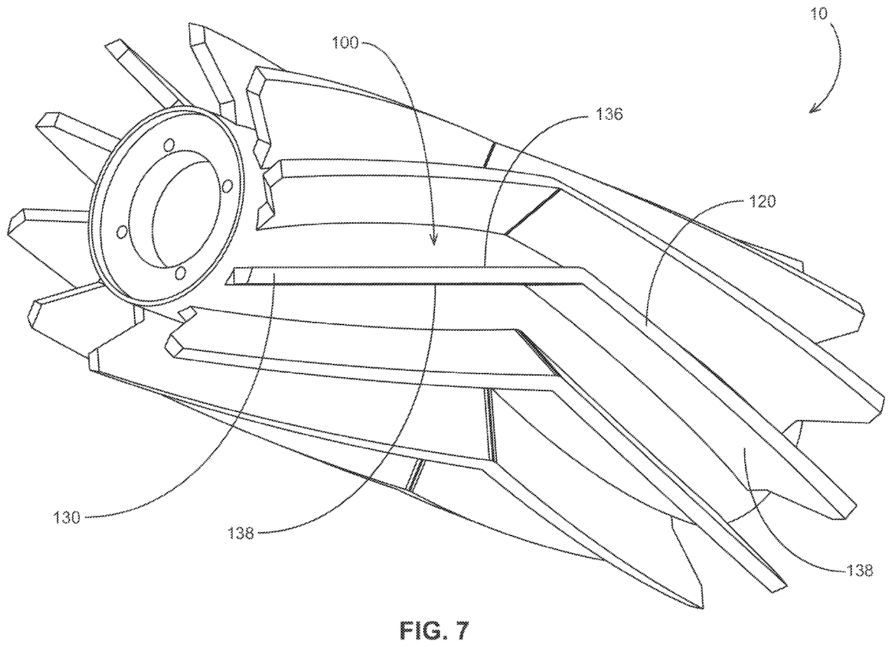

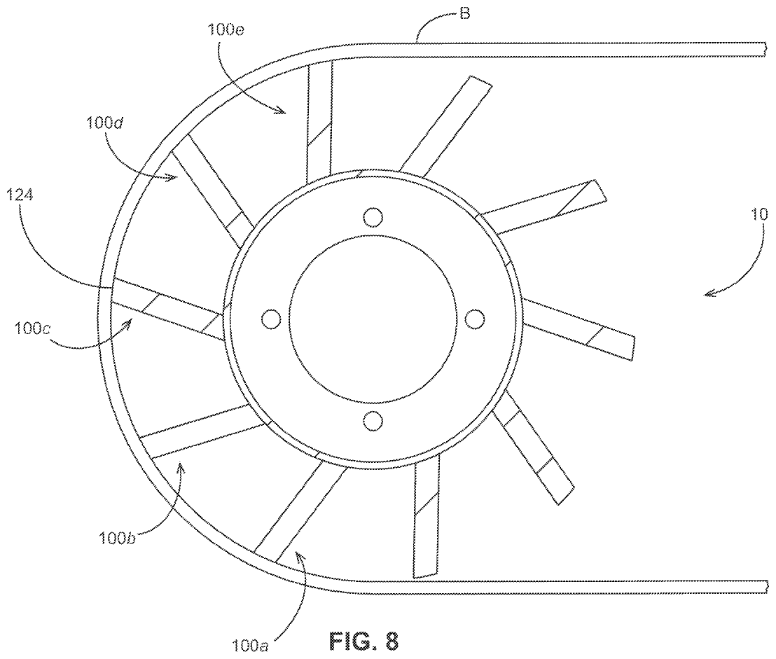

Referring to FIG. 7, the wing portions 120, 130 are optionally planar on one or more surfaces. In various embodiments the wing portions may be generally planar, partially planar, have planar and non-planar portions, etc. Referring to FIG. 2, the wing portions optionally have leading faces (e.g., facing generally along in the direction of rotation D_{R}) and trailing faces (e.g., facing generally opposite the direction of rotation D_{R}). As a first example, wing portion 120 optionally has a leading face 126 and a trailing face 128. As a second example, wing portion 130 optionally has a leading face 136 and a trailing face 138.

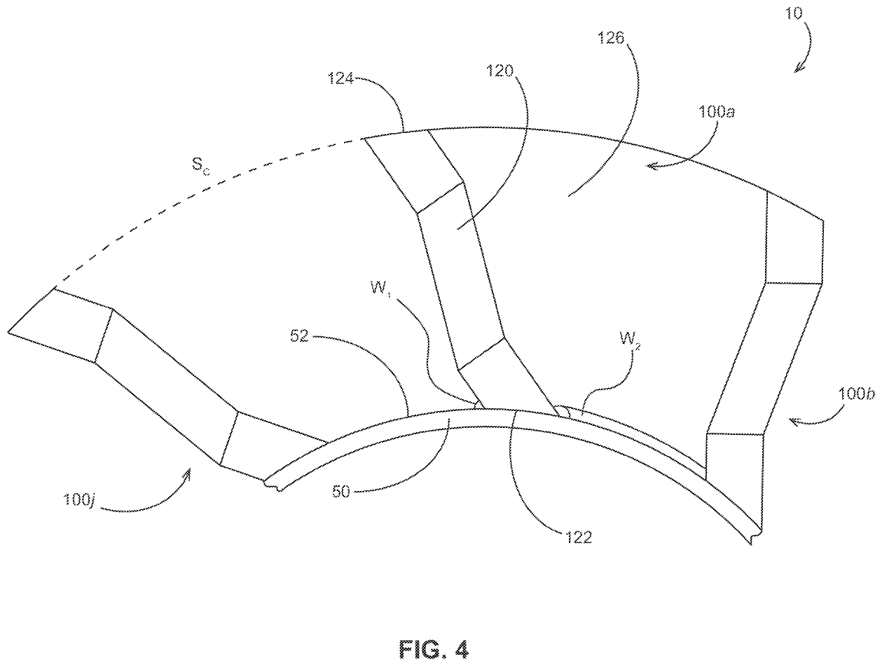

Referring to FIG. 4, a lower surface 122 of the wing portion 120 is optionally beveled. In one embodiment, lower surface 122 is optionally curved. In one embodiment, the lower surface 122 is optionally shaped to complement (e.g., fit to, match, correspond to, continuously contact, etc.) an external surface 52 (e.g., cylindrical surface) of the body 50. In some embodiments, the lower surface 122 complements the surface 52 such that the lower surface 122 engages surface 52 with no space or insubstantial space therebetween. The lower surface 122 is optionally shaped to complement the external surface 52 across at least a portion of the width of the body 50. In some embodiments, the lower surface 122 is shaped to complement the surface 52 at an outer end of wing portion 120 (see FIG. 4) and at an inner end of wing portion 120 (see FIG. 8). In some embodiments, the lower surface 122 is shaped to complement the surface 52 from an outer end of wing portion 120 to an inner end of wing portion 120. It should be appreciated that in some embodiments, in order to enable this complementary shape for an angled orientation of the wing portion 120 relative to axis A_{R} of the body 50, the lower surface 122 is optionally both curved circumferentially along the surface 52 and curved axially along direction of axis A_{R}. In some embodiments, weld seams W₁ and W₂ connect the lower end of wing portion 120 (e.g., the leading and trailing faces thereof, respectively) to the surface 52. In some embodiments, the weld seams W₁, W₂ do not extend between or substantially do not extend between the lower surface 122 and the surface 52.

Referring to FIGS. 4 and 8, an upper surface 124 is of the wing portion 120 is optionally beveled. In one embodiment, the upper surface 124 is optionally curved. The upper surface 124 is optionally shaped to complement (e.g., fit to, match, correspond to, continuously contact, etc.) an imaginary external semi-cylindrical surface Sc. The surface Sc optionally comprises the surface along which the belt B contacts the upper surface 124 in operation. In some embodiments, the upper surface 124 complements the surface Sc such that the upper surface 124 engages belt B in operation with no space or insubstantial space therebetween. The upper surface 124 is optionally shaped to complement the surface Sc across at least a portion of the width of the body 50. In some embodiments, the upper surface 124 is shaped to complement the surface Sc at an outer end of wing portion 120 (see FIG. 4) and at an inner end of wing portion 120 (see FIG. 8). In some embodiments, the upper surface 124 is shaped to complement the surface S_{C} from an outer end of wing portion 120 to an inner end of wing portion 120. It should be appreciated that in some embodiments, in order to enable this complementary shape for an angled orientation of the wing portion 120 relative to axis A_{R} of the body 50, the upper surface 124 is optionally both curved circumferentially along the surface S_{C} and curved axially along direction of axis A_{R}.

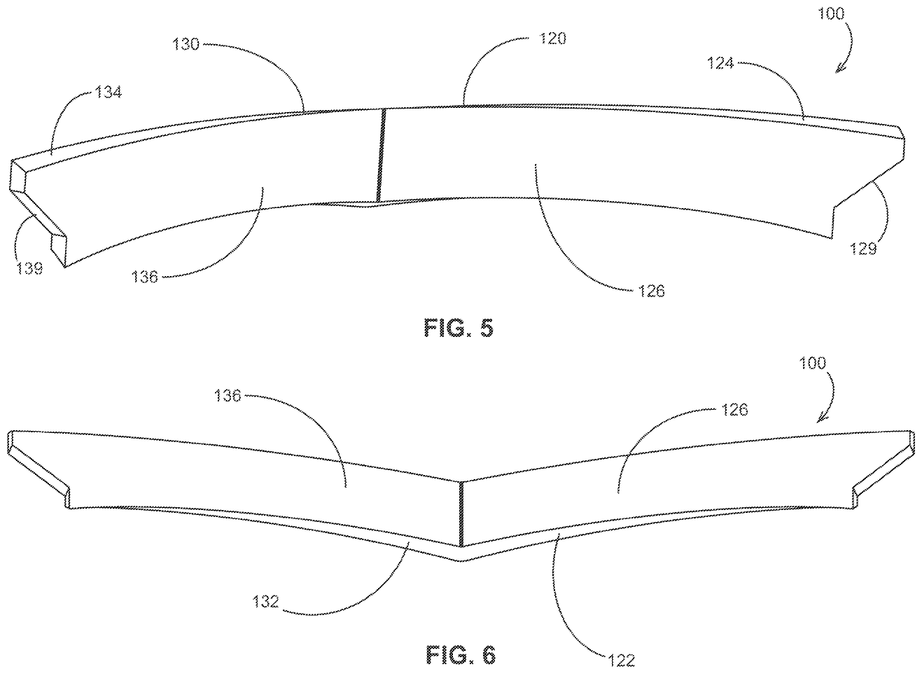

The wing portion 130 has a lower surface 132 (see FIG. 6) and an upper surface 134 (see FIG. 5). Wing portion 130, upper surface 134, and/or lower surface 132 are optionally equivalent to one or more of the embodiments of wing portion 130 and/or surfaces 132, 134 described in the preceding paragraphs.

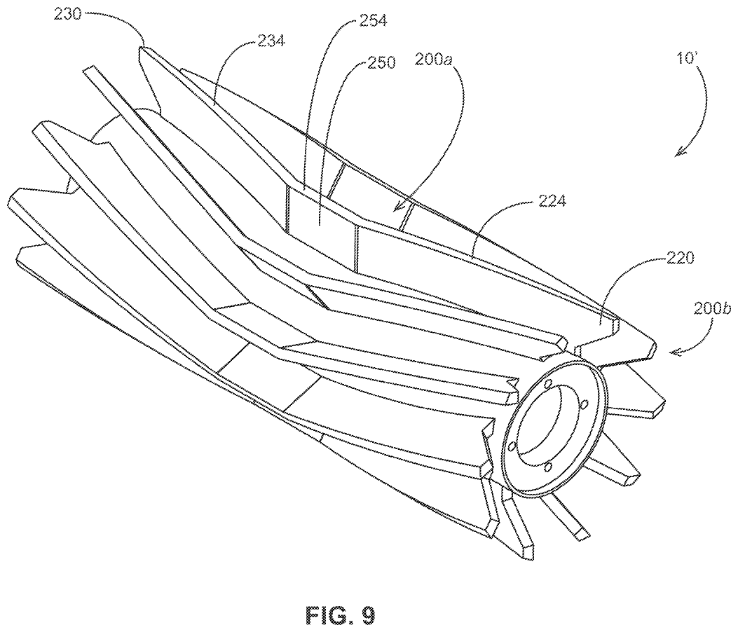

Referring to FIG. 9, an embodiment of a pulley 10′ is illustrated having wings 200 including a first angled wing portion 230, central wing portion 250, and second angled wing portion 220. The wing 200 optionally includes upper surfaces 234, 254, 224 which are optionally curved so as to complement surface Sc. The wing 200 optionally includes lower surfaces which are optionally curved so as to so as to complement the exterior surface of the pulley body. In some embodiments, the wing 200 is formed from a single plate or other part. In some embodiments, the wing 200 is formed from separate plates or other parts and the wing portions are optionally attached to one another (e.g., welded) or not attached according to various embodiments. In yet a further embodiment, wing portions are connected by an intermediate structure positioned therebetween.

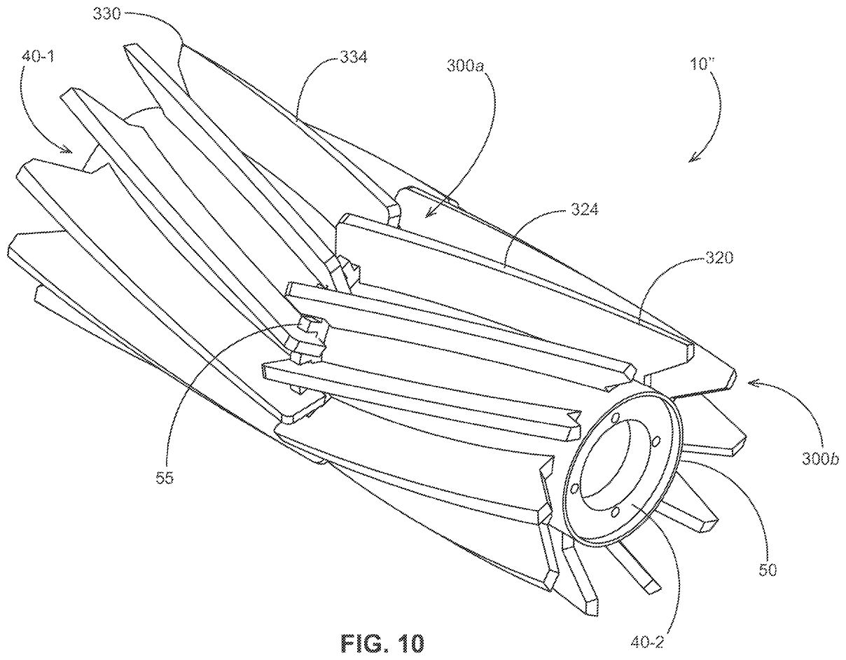

Referring to FIG. 10, an embodiment of a pulley 10″ is illustrated having wings 300 including a first angled wing portion 330 and a second angled wing portion 320. The wing portions 330, 320 are optionally not joined to one another (e.g., not joined directly, not joined indirectly except by being joined to body 50, etc.). The pulley 10″ optionally includes one or more reinforcements 55 disposed or attached to the body 50 (e.g., disposed radially around the body 50 at an axially central location thereof or at another location thereof). The wing portions 320, 330 are optionally attached (e.g., welded) to the reinforcement 55 or not attached to the reinforcement according to various embodiments. The wing 300 optionally includes upper surfaces 334, 324 which are optionally curved so as to complement surface Sc. The wing 300 optionally includes lower surfaces which are optionally curved so as to complement the exterior surface of the pulley body 50.

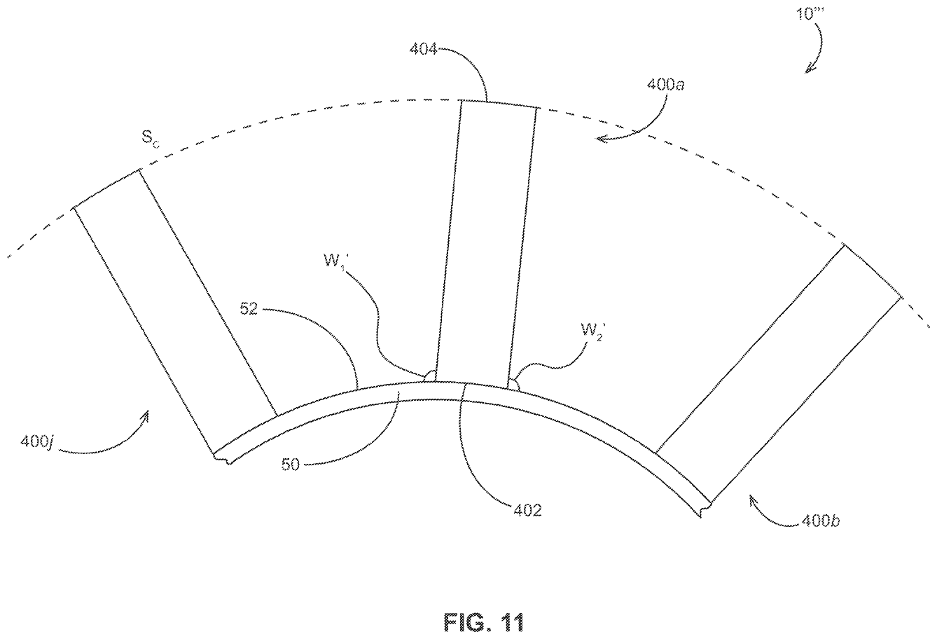

Referring to FIG. 11, a close-up side view of an embodiment of a pulley 10″' is illustrated having a plurality of wings 400 generally aligned with the axis A_{R} of the pulley. Each wing 400 optionally comprises one or more wing portions each extending at least partially (e.g., less than halfway, halfway, more than halfway, entirely, etc.) across the width of the body 50. A lower surface 402 of each wing is optionally curved so as to complement the surface 52 of body 50. An upper surface 404 of each wing is optionally curved so as to complement the surface Sc. Weld seams W1′, W2′ optionally couple each wing to the surface 52 and optionally do not extend or only insubstantially extend between the surface 402 and the surface 52.

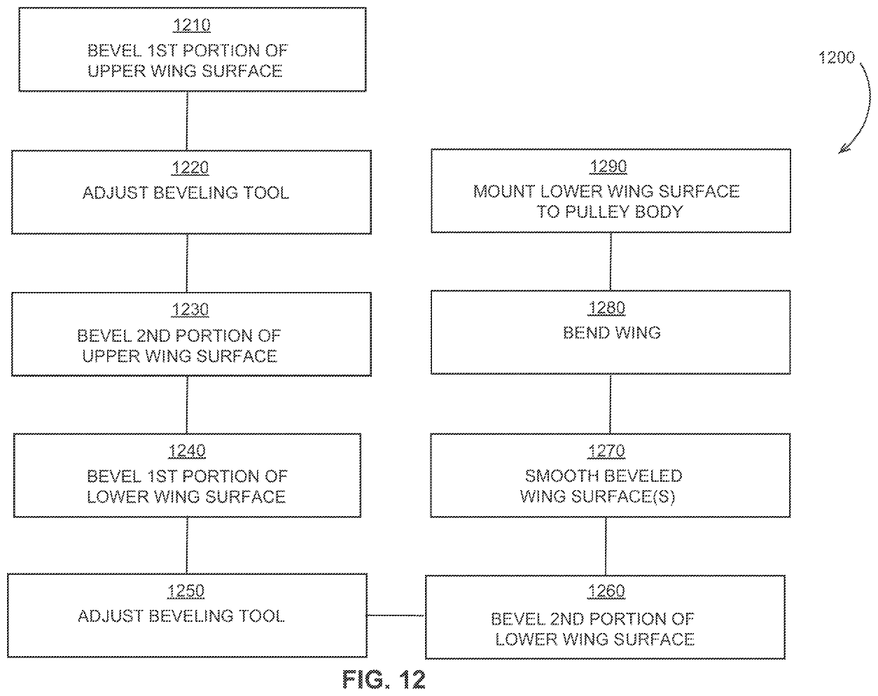

Referring to FIG. 12, an optional method 1200 for manufacturing a pulley according to one or more embodiments described herein (e.g., one of the embodiments of FIG. 1, 9 or 10) is illustrated schematically. At step 1210, a beveling tool (e.g., a cutting tool such as a burn table, plasma table, etc.) is optionally used to optionally bevel a first portion of the upper wing surface. It should be appreciated that each step of method 1200 can be carried out for either a wing or a wing portion depending on the embodiment of pulley being manufactured. At step 1220, the beveling tool is adjusted (e.g., adjusted in angle, position, orientation, etc.). In some embodiments step 1220 is carried out at a location along a length of the wing (e.g., the length parallel to the direction of rotation) at which there exists an inflection point in a desired angle of the upper wing surface bevel (e.g., relative to the bevel tool). An inflection point as described herein may be the point at which there is a change in the desired angle between positive and negative (e.g., from positive or negative or from negative to positive) or the point at which the change in desired angle of the upper wing surface bevel as a function of increasing distance from the end of the wing changes between positive and negative (e.g., from positive to negative or from negative to positive). For example, step 1220 may be carried out at one or more distances along the length of the wing from an end of the wing, e.g. between 0 and 50% of the length of the wing, at 50% of the length of the wing, at approximately 50% of the length of the wing, between 50% and 100% of the length of the wing. At step 1230, a second portion of the upper wing surface is beveled (e.g., with the bevel tool adjusted). At step 1240, the tool is optionally used to optionally bevel a first portion of the lower wing surface. At step 1250, the beveling tool is adjusted (e.g., adjusted in angle, position, orientation, etc.). In some embodiments step 1250 is carried out at a location along the length of the wing (e.g., the length parallel to the direction of rotation) at which there is an inflection point in the desired angle of the lower wing surface bevel (e.g., relative to the bevel tool). At step 1260, a second portion of the lower wing surface is beveled (e.g., with the bevel tool adjusted). At step 1270, one or more wing surfaces (e.g., upper wing surface, lower wing surface) are optionally smoothed (e.g., by grinding, sanding, machining, etc.). At step 1280, the wing is optionally bent. At step 1290, the wing (e.g., lower surface of the wing) is mounted (e.g., by welding) to the pulley body. In some embodiments, a weld seam added at step 1290 does not extend between the lower surface of the wing and the pulley body. It should be appreciated that the steps of process 1200 may be reordered according to various embodiments.

Any ranges recited herein are intended to inclusively recite all values and sub-ranges within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A conveyor pulley configured to contact a conveyor belt along an imaginary semi-cylindrical surface S_{C}, the conveyor pulley comprising:
a body having a cylindrical exterior surface;
a plurality of wings supported by said conveyor body and disposed circumferentially about said conveyor body, each wing comprising at least a first wing portion, wherein a lower portion of said first wing portion is curved so as to complement said exterior surface.

2. The conveyor pulley of claim 1, wherein each wing further comprises at least a second wing portion, wherein a lower portion of said second wing portion is curved so as to complement said exterior surface.

3. The conveyor pulley of claim 2, wherein said first wing portion is angled with respect to a line intersecting an outer end of said first wing portion and parallel to an axis of rotation for the conveyor pulley.

4. The conveyor pulley of claim 2, wherein said first wing portion and said second wing portion are angled with respect to a line intersecting an outer end of the first wing portion and parallel to an axis of rotation for the conveyor pulley.

5. The conveyor pulley of claim 2, wherein said first wing portion is disposed at a non-zero angle relative to said second wing portion.

6. The conveyor pulley of claim 2, wherein an upper portion of said first wing portion is curved so as to complement said surface S_{C}, and wherein an upper portion of said second wing portion is curved so as to complement said surface S_{C}.

7. The conveyor pulley of claim 2, wherein said first wing portion is connected to said second wing portion.

8. The conveyor pulley of claim 2, wherein said first wing portion is connected to said second wing portion by an intermediate structure.

9. The conveyor pulley of claim 2, wherein said first wing portion is not connected to said second wing portion.

10. The conveyor pulley of claim 1, wherein an upper portion of said first wing portion is curved so as to complement said surface Sc.

11. The conveyor pulley of claim 1, wherein a weld seam connects a lower end of said first wing portion to said exterior surface.

12. The conveyor pulley of claim 11, wherein said weld seam does not extend between a lower surface of said first wing portion and said exterior surface.

13. A conveyor pulley configured to contact a conveyor belt along an imaginary semi-cylindrical surface S_{C}, the conveyor pulley comprising:
a body;
a plurality of wings supported by said body and disposed circumferentially about said body, each wing comprising at least a first wing portion, wherein an upper portion of said first wing portion is curved to complement said surface Sc.

14. The conveyor pulley of claim 13, wherein each wing further comprises at least a second wing portion, wherein a lower portion of said second wing portion is curved to complement an exterior surface of the body.

15. The conveyor pulley of claim 14, wherein said first wing portion is angled with respect to a line intersecting an outer end of said first wing portion and parallel to an axis of rotation for the conveyor pulley.

16. The conveyor pulley of claim 14, wherein said first wing portion and said second wing portion are angled with respect to a line intersecting an outer end of the first wing portion and parallel to an axis of rotation for the conveyor pulley.

17. The conveyor pulley of claim 14, wherein said first wing portion is disposed at a non-zero angle relative to said second wing portion.

18. A method of manufacturing a conveyor pulley, the method comprising:
adding a first bevel to a first portion of a lower surface of a wing or wing portion;
adjusting a beveling tool;
adding a second bevel to a second portion of said lower surface; and
mounting said lower surface to a body of the conveyor pulley.

19. The method of claim 18, further comprising:
adding a third bevel to a first portion of an upper surface of said wing or said wing portion;
adjusting said beveling tool;
adding a fourth bevel to a second portion of said upper surface.

20. The method of claim 18, wherein adjusting a beveling tool is carried out at a location along a length of said wing or wing portion at an inflection point in a desired angle of said lower surface.
